(19) United States
(12) Patent Application Publication
(10) Pub. No.: US 2007/0213193 A1
(43) Pub. Date: Sep. 13, 2007

(54) Composition of a binder for enameling a volcanic rock

(76) Inventor: Jonathan Duha Cho, North Hollywood, CA (US)

Correspondence Address: Eugene Oak, 7743 Coldwater Cyn Ave., North Hollywood, CA, 91605, US

(21) Appl. No.: 11/368,700

(22) Filed: Mar. 7, 2006

(51) Int. Cl. C03C 8/00; C03C 8/02; C09D 1/00; B05D 3/00; B05D 3/02; B05D 1/36

(52) U.S. Cl. 501/14; 501/21; 427/299; 427/372.2; 427/402; 106/286.1; 106/286.4

(57) ABSTRACT

A composition of a binder for enameling a porous volcanic rock to decorate the appearance of the volcanic rock with various colors is provided. The binder is comprised of oxides of silica, alumina, ferrous, titanium, calcium, magnesium dispersed in alkaline medium. The binder is impregnated into the porous surface of the volcanic rock followed by air drying on room temperature. After 24 hrs, enamel solution is pasted on the dried surface of the binder layer. The binder protects the porous structure of the volcanic rock from destroying by heat wave when baking the enamel layer up to 1,350° C. within 6 hours.

### BACKGROUND OF THE INVENTION

Volcanic rock is a good support or vessel for raising plants thereon because the volcanic rock itself contains much kind of pores, from micro-pores to macro-pores. Moisture is reserved in the pores with ingredients dissolved and air pass through the pores to allow the plants breath. Weight of the volcanic rock is light compared to other flowerpots made of porcelain and ceramics due to the porous structure of the volcanic rocks. In addition to this, various shape of the volcanic rocks provide a unique mood to interior. In spite of the many advantageous merit, volcanic rocks are weak in mechanical strength. Therefore, it is necessary to reinforce a volcanic rock to keep the original natural shape for long time. Enameling is not only a way of decorating the surface of the volcanic rock but also a way of reinforcing the structure of the volcanic rock. In many part of the world, it is prohibited by local authorities to take out any piece of rocks from volcano area but fabricated sample of volcanic rock is allowed. It is purpose of the current invention to provide a mean of enameling a volcanic rock without damaging the original shape of a volcanic rock.

### FIELD OF THE INVENTION

Current application relates to a binder, especially for enameling a porous volcanic rock to decorate the appearance of the volcanic rock with various colors.

### DESCRIPTION OF THE PRIOR ART

U.S. Pat. No. 6,338,830 and U.S. Pat. No. 5,948,726 to Moskovitz, et al. illustrates a method for producing an adsorbent and/or catalyst and binder system comprising I) mixing components comprising (a) a binder comprising a colloidal metal oxide or colloidal metalloid oxide, (b) an oxide adsorbent and/or catalyst particle, and (c) an acid, (ii) removing a sufficient amount of water from the mixture to cross-link components a and b to form an adsorbent and/or catalyst and binder system. The invention also relates to particles made by the process, binders, and methods for remediating contaminants in a stream. The porous mineral is selected from the group consisting of alkali or alkaline earth metal hydroxides, alkali or alkaline earth metal silicates, aluminum silicates, iron(II) and iron(III) silicates and mixtures thereof, alkali or alkaline earth metal pyrosilicates, aluminum pyrosilicates, iron(II) and iron(III) pyrosilicates and mixtures thereof, alkali or alkaline earth metal carbonates, alkali or alkaline earth metal bicarbonates, alkali or alkaline earth metal phosphates, alkali or alkaline earth metal pyrophosphates, ammonia, organic amines, and cements, and combinations thereof. The inventions also relates to particles made by the process, binders, and methods for remediating contaminants in a stream. Wherein component (b) comprises aluminum oxide, aluminum oxide, titanium dioxide, copper oxide, vanadium pent oxide, silicon dioxide, manganese dioxide, iron oxide, zinc oxide, zeolite, activated carbon, peat, zinc oxide, zirconium oxide or zeolite or tin particle.

None of the prior art illustrates a binder that can protect a volcanic stone from heat wave and facilitate binding of enamel as provided in the current invention.

### SUMMARY OF THE INVENTION

Volcanic rock is a good support or vessel for raising plants thereon because the volcanic rock itself contains much kind of pores, from micro-pores to macro-pores. Moisture is reserved in the pores with ingredients dissolved and air pass through the pores to allow the plants breath. Weight of the volcanic rock is light compared to other flowerpots made of porcelain and ceramics due to the porous structure of the volcanic rocks. In addition to this, various shape of the volcanic rocks provide a unique mood to interior. In spite of the many advantageous merit, volcanic rocks are weak in mechanical strength. Therefore, it is necessary to reinforce a volcanic rock to keep the original natural shape for long time. Enameling is not only a way of decorating the surface of the volcanic rock but also a way of reinforcing the structure of the volcanic rock. In many part of the world, it is prohibited by local authorities to take out any piece of rocks from volcano area but fabricated sample of volcanic rock is allowed. It is purpose of the current invention to provide a mean of enameling a volcanic rock without damaging the original shape of a volcanic rock. A composition of a binder for enameling a porous volcanic rock to decorate the appearance of the volcanic rock with various colors is provided. The binder is comprised of oxides of silica, alumina, ferrous, titanium, calcium, magnesium dispersed in alkaline medium. The binder is impregnated into the pores of the volcanic rock followed by air drying on room temperature. After 24 hrs, enamel solution is pasted on the dried surface of the binder layer. The binder protects the porous structure of the volcanic rock from destroying by heat wave when baking the enamel layer up to 1,350° C. within 6 hours.

### BRIEF DESCRIPTION OF THE DRAWINGS

FIG. 1 is a schematic block diagram representing a procedure of treating a volcanic stone with enamel solution.

FIG. 2 is a schematic drawing showing relative position of the volcanic stone, binder layer and the enamel layer.

FIG. 3 is a graph diagram representing the relationship between time and the temperature.

### DETAILED DESCRIPTION OF THE PREFERRED EMBODIMENT

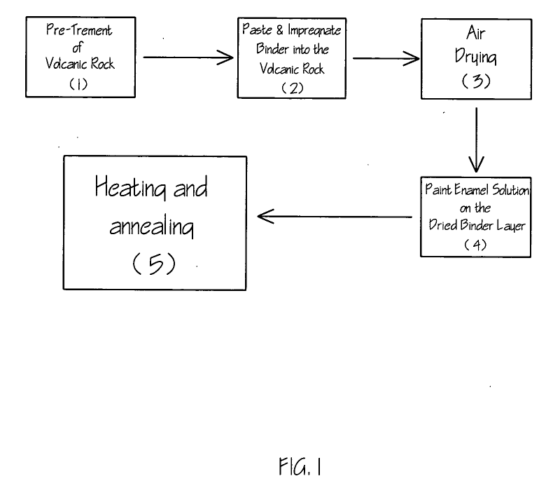

FIG. 1 is a schematic block diagram representing a procedure of treating a volcanic stone with enamel solution. The procedure is comprised of five steps of; 1) volcanic rock cleaning step (1), 2) impregnating step (2) of filling the pores of the volcanic rock with binder paste, 3) air drying step (3), 4) pasting step of an enamel solution on the binder layer, and 5) heat treatment step (5) of heating and annealing.

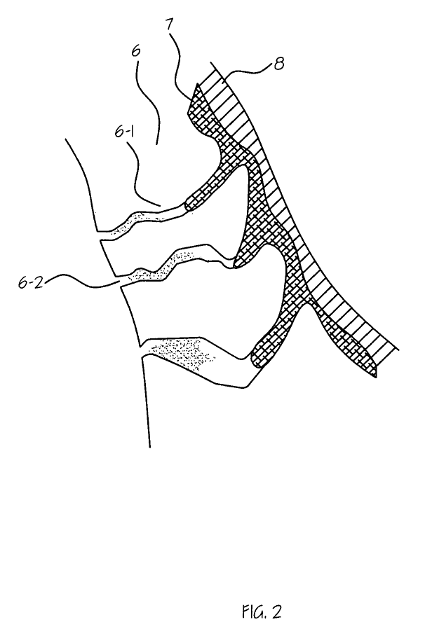

FIG. 2 is a schematic drawing showing relative position of the volcanic stone, binder layer and the enamel layer. The volcanic rock (6) has many pores (6-1). Dusts (6-2) and moistures (6-3) are trapped in the pore (6-1). The volcanic rock (6) is washed with water and treated with hot air to blow out dusts (6-2) and moisture (6-3) from the coarse surface and the pores (6-1) of the volcanic rock (6). Leave the rocks in the air drying oven for 24 hours to remove moisture (6-3) left in a deep inside of the pore (6-1) of the rocks. If moisture (6-3) is left in the pore (6-1) of the volcano rock (6) and binder (7) is pasted thereon, the vapor pressure of the moisture increases drastically and pushes out the binder from the pore (6-1) when the rock is exposed to heat treatment step (5). Then the vapor pressure breaks the porous structure of the rock. Though the volcanic rock (6) samples are treated properly, it is not easy to find a composition of a binder (7) that bound properly on the coarse surfaces of the volcanic rock (6).

Several samples of binders are prepared to find out optimal composition. The results are summarized in Table 1.

TABLE 1

| | Wt % | | |
|---|---|---|---|
| Components | Sample 1 | Sample 2 | Sample 3* |
| SiO₂ | 46.2 | 46.2 | 51.64 |
| Al₂O₃ | 37.7 | 37.7 | 27.99 |
| Fe₂O₃ | 0.4 | 0.4 | 2.07 |
| TiO₂ | 2.1 | 2.1 | 1.00 |
| CaO | 0.04 | 0.04 | 0.24 |
| MgO | 0.05 | 0.05 | 1.51 |
| Alkaline | 0.1 | 0.3 | 0.50 |
| H₂O | 13.41 | 13.38 | 15.05 |

*Sample 3 is optimized sample for stable heat treatment

As shown in the Table 1, the binder (7) is diluted in about 15% of water. Therefore, the binder (7) is in a paste state and is pasted on the surface of the volcanic rock (6) to allow the binder (7) soak into the pores (6-1) of the volcanic rock (6). The binder (7) impregnated volcanic rock (6) is exposed to blowing air for at least 24 hours to remove the water introduced with the binder components. Insufficient drying results in breakage of the volcanic rock (6).

Though the binder (7) paste is properly dried, the composition of the binder is critical for successful enameling and heat treatment. Sample 1 and sample 2 did not make successful enameled volcanic rock. Only sample 3 is successful. By comparing the samples 1, 2 and 3, it is found that the key point is that the concentration of SiO₂ should be at least 50%. Concentration of Al₂O₃ is decreased about 10%. Except TiO₂, concentration of other components are slightly increased.

After drying in the air, the binder (7) layer left in the pores (6-1) not only blocks the pores (6-1) but also binds the weak surface of the volcanic rock (6) to withstand the heat wave during the heat and annealing step (5).

Various kind of enamel (8) is pasted on the dried surface of the binder (7) layer depends on the color needed. Enamels for different color from Clayusa are used for enameling volcanic rock (6). Clayusa's product no. WC-556 is used for red color, SG89 is used for blue color, and SG-117 for black color.

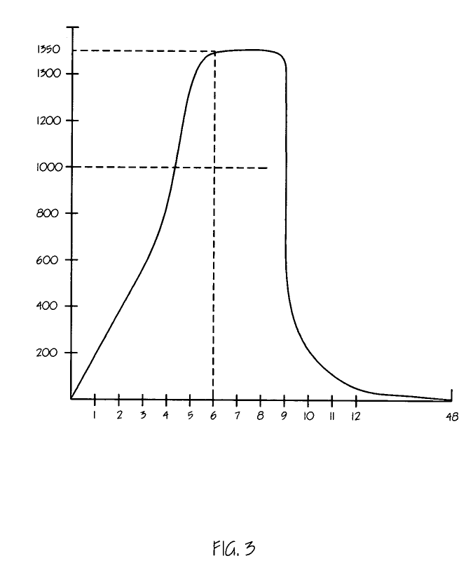

FIG. 3 is a graph diagram representing the relationship between time and the temperature. Conventional electric furnace equipped with a programmable temperature controller having maximum temperature limit 1,500° C. is used for heat treatment and annealing step (5) of the enameled volcanic rock (6) using the binder (7) of the current application.

Up to 800° C., the temperature is increased at a heating rate of 200° C. per hour. After that the heating rate is adjusted to reach 1,350° C. within two hours. The programmable temperature controller avoids temperature shooting of the furnace. At 1,350° C., the temperature is hold for three hours for annealing. After three hours, which is nine hours from the beginning, the electric furnace is cut off. Then the temperature drops down to 200° C. within 30 minutes. Leave the heat treated enamel coated volcanic rock with the binder of the current application for another 48 hours in the furnace. Minor adjustment of the heating rate and maximum temperature is needed for different color and glaze of the enamel.

Natural gas burner and furnace can be used in the heating and annealing step (5).

What is claimed is:

1. A composition of a binder, which is comprised of;
SiO₂ in the range of 40 to 55 wt %, and
Al₂O₃ in the range of 20 to 40 wt %, and
Fe₂O₃ in the range of 0.1 to 5 wt %, and
TiO₂ in the range of 0.5 to 3 wt %, and
CaO in the range of 0.01 to 1.0 wt %, and
MgO in the range of 0.01 to 2.0 wt %, and
Alkaline in the range of 0.1 to 1.0 wt %, and
H₂O in the range of 10 to 20 wt %, for use in a procedure of enameling a volcanic rock that is comprised of five steps of;
volcanic rock cleaning step of washed with water and treat with hot air to blow out dusts and moisture from the coarse surface and leave the rocks in the air drying oven for 24 hours to remove moisture left in a deep inside of the pore of the rocks, and
impregnating step of filling the pores of the volcanic rock with binder paste, and
air drying step of blowing air to the binder impregnated volcanic rock for at least 24 hours to remove the water introduced with the binder components, and
pasting step of an enamel solution on the binder layer, and
heat treatment step of;
increasing the temperature up to 800° C. at a heating rate of 200° C./hr, and
reach 1,350° C. within two hours by adjusting the heating rate, and
stay at 1,350° C. for three hours for annealing, and cut off electric furnace to allow the temperature drops down to 200° C. within 30 minutes.

2. A composition of a binder of claim 1, wherein SiO₂ is 51.46 wt %, Al₂O₃ is 27.99 wt %, Fe₂O₃ is 2.07 wt %, TiO₂ is 1.00 wt %, CaO is 0.24 wt %, MgO is 1.51 wt %, Alkaline is 0.5 wt %, and H₂O is 15.05 wt %,
